(19) United States
(12) Patent Application Publication
(10) Pub. No.: US 2011/0317778 A1
(43) Pub. Date: Dec. 29, 2011

(54) MULTI-BIT HARQ-ACK AND RANK INDICATOR TRANSMISSION ON PHYSICAL UPLINK SHARED CHANNEL WITH SINGLE USER MULTIPLE INPUT-MULTIPLE OUTPUT OPERATION

(75) Inventors: Kari J. Hooli, Oulu (FI); Esa T. Tiirola, Kempele (FI); Timo E. Lunttila, Espoo (FI); Kari P. Pajukoski, Oulu (FI)

(73) Assignee: Nokia Siemens Networks Oy

(21) Appl. No.: 13/167,917

(22) Filed: Jun. 24, 2011

Related U.S. Application Data
(60) Provisional application No. 61/398,588, filed on Jun. 28, 2010.

(51) Int. Cl. H04L 27/28

(52) U.S. Cl. 375/260

(57) ABSTRACT

In accordance with an exemplary embodiment of the invention, there is at least a method, computer program instructions, and an apparatus to perform operations including replicating and time-aligning, at a wireless communication device, more than two hybrid automatic repeat request acknowledgment or rank indicator bits across layers and codewords of an uplink transmission signal, and providing an ability to define per codeword either an effective modulation order or a coding rate when a different modulation order is configured to the codewords so that time-alignment across all the layers and the codewords of the uplink transmission signal is maintained. Further, in accordance with the embodiments there is receiving an uplink transmission signal comprising more than two hybrid automatic repeat request acknowledgment or rank indicator bits across layers and codewords of the uplink transmission signal, and demodulating the uplink transmission signal, where either an effective modulation order or a coding rate per codeword is modified so that time-alignment across all the layers and the codewords of the uplink transmission signal is maintained.

### CROSS-REFERENCE TO RELATED APPLICATIONS

This patent application claims priority under 35 U.S.C. §119(e) from Provisional Patent Application No. 61/398,588, filed Jun. 28, 2010, the disclosure of which is incorporated by reference herein in its entirety.

### TECHNICAL FIELD

The exemplary and non-limiting embodiments of this invention relate generally to wireless communication systems, methods, devices and computer programs and, more specifically, relate to signaling between a user equipment and a network access node in support of single user multiple input-multiple output (MIMO) operation.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the description and/or in the Figures are herewith defined as follows:

3GPP third generation partnership project
ACK acknowledge
BS base station
BW bandwidth
CQI channel quality indicator
CW codeword
DFT discrete Fourier transform
DL downlink (eNB towards UE)
eNB E-UTRAN Node B (evolved Node B)
EPC evolved packet core
E-UTRAN evolved UTRAN (LTE)
FDMA frequency division multiple access
HARQ hybrid automatic repeat request
HSPA high speed packet access
IMTA international mobile telecommunications association
ITU-R international telecommunication union-radiocommunication sector
LTE long term evolution of UTRAN (E-UTRAN)
LTE-A LTE advanced
MAC medium access control (layer 2, L2)
MCS modulation coding scheme
MIMO multiple input-multiple output
ML maximum likelihood
MM/MME mobility management/mobility management entity
NodeB base station
OFDMA orthogonal frequency division multiple access
O&M operations and maintenance
PDCP packet data convergence protocol
PHY physical (layer 1, L1)
PMI precoding matrix index
PUCCH physical uplink control channel
PUSCH physical uplink shared channel
QAM quadrature amplitude modulation
QPSK quadrature phase shift keying
Rel release
RI rank indicator
RLC radio link control
RRC radio resource control
RRM radio resource management
SGW serving gateway
SC-FDMA single carrier, frequency division multiple access
SU-MIMO single user MIMO
TDD time division duplexing
TDM time division multiplexing
UCI uplink control information
UE user equipment, such as a mobile station, mobile node or mobile terminal
UL uplink (UE towards eNB)
UPE user plane entity
UTRAN universal terrestrial radio access network

One modern communication system is known as evolved UTRAN (E-UTRAN, also referred to as UTRAN-LTE or as E-UTRA). In this system the DL access technique is OFDMA, and the UL access technique is SC-FDMA.

One specification of interest is 3GPP TS 36.300, V8.11.0 (2009-12), 3rd Generation Partnership Project; Technical Specification Group Radio Access Network; Evolved Universal Terrestrial Radio Access (E-UTRA) and Evolved Universal Terrestrial Access Network (EUTRAN); Overall description; Stage 2 (Release 8), incorporated by reference herein in its entirety. This system may be referred to for convenience as LTE Rel-8. In general, the set of specifications given generally as 3GPP TS 36.xyz (e.g., 36.211, 36.311, 36.312, etc.) may be seen as describing the Release 8 LTE system. More recently, Release 9 versions of at least some of these specifications have been published including 3GPP TS 36.300, V9.3.0 (2010-03).

FIG. 1A reproduces FIG. 4.1 of 3GPP TS 36.300 V8.11.0, and shows the overall architecture of the EUTRAN system (Rel-8). Reference can also be made to FIG. 1B. The E-UTRAN system includes eNBs, providing the E-UTRAN user plane (PDCP/RLC/MAC/PHY) and control plane (RRC) protocol terminations towards the UEs. The eNBs are interconnected with each other by means of an X2 interface. The eNBs are also connected by means of an S1 interface to an EPC, more specifically to a MME by means of a S1 MME interface and to a S-GW by means of a S1 interface (MME/S-GW 4). The S1 interface supports a many-to-many relationship between MMEs/S-GWs/UPEs and eNBs.

The eNB hosts the following functions:

functions for RRM: RRC, Radio Admission Control, Connection Mobility Control, Dynamic allocation of resources to UEs in both UL and DL (scheduling);
IP header compression and encryption of the user data stream;
selection of a MME at UE attachment;
routing of User Plane data towards the EPC (MME/S-GW);
scheduling and transmission of paging messages (originated from the MME);
scheduling and transmission of broadcast information (originated from the MME or O&M); and
a measurement and measurement reporting configuration for mobility and scheduling.

Of particular interest herein are the further releases of 3GPP LTE (e.g., LTE Rel-10) targeted towards future IMTA systems, referred to herein for convenience simply as LTE-Advanced (LTE-A). Reference in this regard may be made to 3GPP TR 36.913, V9.0.0 (2009-12), 3rd Generation Partnership Project; Technical Specification Group Radio Access Network; Requirements for Further Advancements for E-UTRA (LTE-Advanced) (Release 9). Reference can also be made to 3GPP TR 36.912 V9.3.0 (2010-06) Technical Report 3rd Generation Partnership Project; Technical Specification Group Radio Access Network; Feasibility study for Further Advancements for E-UTRA (LTE-Advanced) (Release 9).

A goal of LTE-A is to provide significantly enhanced services by means of higher data rates and lower latency with reduced cost. LTE-A is directed toward extending and optimizing the 3GPP LTE Rel-8 radio access technologies to provide higher data rates at lower cost. LTE-A will be a more optimized radio system fulfilling the ITU-R requirements for IMT-Advanced while keeping the backward compatibility with LTE Rel-8.

As is specified in 3GPP TR 36.913, LTE-A should operate in spectrum allocations of different sizes, including wider spectrum allocations than those of LTE Rel-8 (e.g., up to 100 MHz) to achieve the peak data rate of 100 Mbit/s for high mobility and 1 Gbit/s for low mobility. It has been agreed that carrier aggregation is to be considered for LTE-A in order to support bandwidths larger than 20 MHz. Carrier aggregation, where two or more component carriers (CCs) are aggregated, is considered for LTE-A in order to support transmission bandwidths larger than 20 MHz. The carrier aggregation could be contiguous or non-contiguous. This technique, as a bandwidth extension, can provide significant gains in terms of peak data rate and cell throughput as compared to non-aggregated operation as in LTE Rel-8.

A terminal may simultaneously receive one or multiple component carriers depending on the capabilities of the terminal. A LTE-A terminal with reception capability beyond 20 MHz can simultaneously receive transmissions on multiple component carriers. A LTE Rel-8 terminal can receive transmissions on a single component carrier only, provided that the structure of the component carrier follows the Rel-8 specifications. Moreover, it is required that LTE-A should be backwards compatible with Rel-8 LTE in the sense that a Rel-8 LTE terminal should be operable in the LTE-A system, and that a LTE-A terminal should be operable in a Rel-8 LTE system.

FIG. 1C shows an example of the carrier aggregation, where M Rel-8 component carriers are combined together to form M×Rel-8 BW (e.g. 5×20 MHz=100 MHz given M=5). Rel-8 terminals receive/transmit on one component carrier, whereas LTE-A terminals may receive/transmit on multiple component carriers simultaneously to achieve higher (wider) bandwidths.

FIG. 1D depicts the use of aggregate component carriers in terms of the system bandwidth. In FIG. 1D, the total system bandwidth is shown as 100 MHz (frequency). In Case 1, a first case for LTE-A with aggregated component carriers, all of this bandwidth is aggregated and used by a single UE device. In case 2, the bandwidth is partially aggregated into two 40 MHz groups, leaving a 20 MHz grouping. This remaining bandwidth may be used, for example, by a Release 8 LTE UE, which only requires 20 MHz. In Case 3, none of the CCs are aggregated and so five 20 MHz components are available for use by five different UEs.

It is noted with respect to LTE-Advanced that with UL single user spatial multiplexing up to two transport blocks can be transmitted from a scheduled UE in a subframe per uplink component carrier. Each transport block has its own MCS level. Depending on the number of transmission layers, the modulation symbols associated with each of the transport blocks are mapped onto one or two layers according to the same principle as in Rel-8 E-UTRA DL spatial multiplexing. The transmission rank can be adapted dynamically. In the following table, taken from 3GPP TS 36.211 V9.1.0 (2010-03) Technical Specification 3rd Generation Partnership Project; Technical Specification Group Radio Access Network; Evolved Universal Terrestrial Radio Access (E-UTRA); Physical Channels and Modulation (Release 9), the transport block (i.e., codeword) to layer mapping used in Rel-8 DL is shown. In the table, x⁽ⁿ⁾ (i) and d^{(m)} (i) denote the ith symbol on nth layer and mth transport block, respectively.

TABLE
Codeword-to-layer mapping for spatial multiplexing
[as per 3GPP TS 36.211]

| Number | Number | | |
|---|---|---|---|
| of | of code | Codeword-to-layer mapping | |
| layers | words | i = 0,1, . . . , M_{symb}^{layer}−1 | |
| 1 | 1 | x⁽⁰⁾ (i) = d⁽⁰⁾ (i) | M_{symb}^{layer} = M_{symb}⁽⁰⁾ |
| 2 | 2 | x⁽⁰⁾ (i) = d⁽⁰⁾ (i) | M_{symb}^{layer} = M_{symb}⁽⁰⁾ = M_{symb}⁽¹⁾ |
| | | x⁽¹⁾ (i) = d⁽¹⁾ (i) | |
| 2 | 1 | x⁽⁰⁾ (i) = d⁽⁰⁾ (2i) | M_{symb}^{layer} = M_{symb}⁽⁰⁾/2 |
| | | x⁽¹⁾ (i) = d⁽¹⁾ (2i + 1) | |
| 3 | 2 | x⁽⁰⁾ (i) = d⁽⁰⁾ (i) | M_{symb}^{layer} = M_{symb}⁽⁰⁾ = |
| | | x⁽¹⁾ (i) = d⁽¹⁾ (2i) | M_{symb}⁽¹⁾ [symbol] |
| | | x⁽²⁾ (i) = d⁽¹⁾ (2i + 1) | |
| 4 | 2 | x⁽⁰⁾ (i) = d⁽⁰⁾ (2i) | M_{symb}^{layer} = M_{symb}⁽⁰⁾/2 = |
| | | x⁽¹⁾ (i) = d⁽⁰⁾ (2i + 1) | M_{sy} [symbol] ⁽¹⁾ |
| | | x⁽²⁾ (i) = d⁽¹⁾ (2i) | |
| | | x⁽³⁾ (i) = d⁽¹⁾ (2i + 1) | |

[symbol]

indicates data missing or illegible when filed

Uplink L1/L2 control signaling is divided into two classes in LTE Rel-8: Control signaling in the absence of UL data, which takes place on PUCCH (Physical Uplink Control Channel), and control signaling in the presence of UL data, which takes place on PUSCH (Physical Uplink Shared Channel). Due to the single carrier limitations, simultaneous transmission of PUCCH and PUSCH is not allowed in LTE Rel-8.

With respect to UCI transmission in the presence of UL data, FIG. 1E shows the principle of control and data multiplexing within the SC-FDMA symbol (block) on the PUSCH. In order to maintain the single carrier properties, transmitted signal data and different control symbols are multiplexed prior to the DFT by means of TDM multiplexing. The data part of PUSCH is punctured (i.e., replaced with) by the number of control symbols allocated in the given subframe. Data and different control fields (HARQ-ACK, CQI/PMI, Rank Indicator) are coded and modulated separately before multiplexing them into the same SC-FDMA symbol block. Different coding rates for control are achieved by occupying different number of symbols for each control field.

It was decided in RAN1#55bis that control-data decoupling (simultaneous PUCCH and PUSCH transmission) is supported in addition to TDM type multiplexing. In the light of this decision these two options are applicable also in the case of SU-MIMO. Hence, there is a clear need for TDM solution applicable to SU-MIMO.

It was decided in RAN1#61 that in both single component carrier (CC) and multi-CC cases HARQ-ACK and RI is replicated across all layers of both CWs and TDM multiplexed with data such that UCI symbols are time-aligned across all layers. This allows for effectively rank 1 transmission of UCI, irrespective of the transmission rank used for PUSCH data transmission.

It is rather straightforward to apply the required replication and time alignment of HARQ-ACK and RI bits across both CWs when number of bits is one or two. In such cases, used modulation is forced to be effectively QPSK irrespective of the underlying PUSCH data modulation by appropriate selection of constellation points used for UCI. Reference in this regard can be made, for example, to 3GPP TS 36.212 V9.2.0 (2010-06) Technical Specification, 3^{rd} Generation Partnership Project; Technical Specification Group Radio Access Network; Evolved Universal Terrestrial Radio Access (E-UTRA); Multiplexing and channel coding (Release 9), Section 5.2.2.6. herein.

However, a full modulation constellation is used in LTE Rel-8 with more than 2 bits of HARQ-ACK. In SU-MIMO, CWs may have different modulation orders. Thus, UCI time alignment across both CWs is not maintained with a straightforward application of the Rel-8 approach.

### SUMMARY

In an exemplary aspect of the invention, there is a method comprising replicating and time-aligning, at a wireless communication device, more than two hybrid automatic repeat request acknowledgment or rank indicator bits across layers and codewords of an uplink transmission signal, and defining per codeword either an effective modulation order or a coding rate when a different modulation order is configured to the codewords so that time-alignment across all the layers and the codewords of the uplink transmission signal is maintained.

In another exemplary aspect of the invention, there is an apparatus comprising at least one processor, and at least one memory including computer program code, where the at least one memory and the computer program code are configured, with the at least one processor, to cause the apparatus to at least replicate and time-align, at a wireless communication device, more than two hybrid automatic repeat request acknowledgment or rank indicator bits across layers and codewords of an uplink transmission signal, and define per codeword either an effective modulation order or a coding rate when a different modulation order is configured to the codewords so that time-alignment across all the layers and the codewords of the uplink transmission signal is maintained.

In another exemplary aspect of the invention, there is an apparatus comprising means replicating and time-aligning, at a wireless communication device, more than two hybrid automatic repeat request acknowledgment or rank indicator bits across layers and codewords of an uplink transmission signal, and means for defining per codeword either an effective modulation order or a coding rate when a different modulation order is configured to the codewords so that time-alignment across all the layers and the codewords of the uplink transmission signal is maintained.

In another exemplary aspect of the invention, this is a method comprising receiving an uplink transmission signal comprising more than two hybrid automatic repeat request acknowledgment or rank indicator bits across layers and codewords of the uplink transmission signal, and demodulating the uplink transmission signal, where either an effective modulation order or a coding rate per codeword is modified so that time-alignment across all the layers and the codewords of the uplink transmission signal is maintained.

In still another exemplary aspect of the invention, there is an apparatus comprising at least one processor, and at least one memory including computer program code, where the at least one memory and the computer program code are configured, with the at least one processor, to cause the apparatus to at least receive an uplink transmission signal comprising more than two hybrid automatic repeat request acknowledgment or rank indicator bits across layers and codewords of the uplink transmission signal, and demodulate the uplink transmission signal, where either an effective modulation order or a coding rate per codeword is modified so that time-alignment across all the layers and the codewords of the uplink transmission signal is maintained

In yet another exemplary aspect of the invention, there is an apparatus comprising means for receiving an uplink transmission signal comprising more than two hybrid automatic repeat request acknowledgment or rank indicator bits across layers and codewords of the uplink transmission signal, and means for demodulating the uplink transmission signal, where either an effective modulation order or a coding rate per codeword is modified so that time-alignment across all the layers and the codewords of the uplink transmission signal is maintained.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1A reproduces Figure 4.1 of 3GPP TS 36.300, and shows the overall architecture of the EUTRAN system.

FIG. 1B presents another view of the EUTRAN system.

FIG. 1C shows an example of carrier aggregation as proposed for the LTE-A system.

FIG. 1D depicts the use of aggregate component carriers in terms of system bandwidth.

FIG. 1E shows the principle of data and control modulation on the PUSCH.

FIG. 2 shows a simplified block diagram of various electronic devices that are suitable for use in practicing the exemplary embodiments of this invention.

FIG. 3 illustrates a simple block diagram describing a method in accordance with the exemplary embodiments of the invention.

FIG. 4 illustrates a simple block diagram describing a method in accordance with the exemplary embodiments of the invention.

### DETAILED DESCRIPTION

The exemplary embodiments of this invention pertain at least in part to uplink control information (UCI) transmission on PUSCH (Physical Uplink Shared Channel), and in particular in the case of SU-MIMO and spatial multiplexing. UCI signalling corresponds to transmission of data-non-associated signals such as HARQ-ACK due to downlink transmission and downlink channel state information, such as CQI, PMI and RI in the uplink.

The inventors have realized that a specific arrangement is needed for replicating multiple HARQ-ACK and RI bits across both CWs so that UCI time alignment across layers and codewords is maintained when CWs use different modulation. Additionally, the arrangement should be such that reasonable spectral efficiency is maintained for UCI, and additional system complexity and standardization effort should be minimized.

In LTE Rel-10 there will be need to transmit in the UL multiple (more than 2) HARQ-ACK and potentially RI bits on UCI due to TDD, carrier aggregation (CA), DL MIMO, and combinations of these. A most straightforward way would be to use and potentially extend the LTE Rel-8 approach for multiple HARQ-ACK bits with TDD based on the use of Reed-Muller encoding. The corresponding portion from the above mentioned 3GPP TS 36.212 Section 5.2.2.6 is reproduced below.

“For the case that HARQ-ACK consists of more than two bits information, i.e. [o₀^{ACK}o₁^{ACK} . . . o₀_{^{ACK}}₋₁^{ACK}] with O^{ACK}<2, the bit sequence q₀^{ACK}, q₁^{ACK}, q₂^{ACK}, . . . , q_{Q}_{_{ACK}}₋₁^{ACK} is obtained as

$${q}_{i}^{ACK} = {\sum }_{n = 0}^{{O}^{ACK} - 1} ( {o}_{n}^{ACK} \cdot {M}_{( i mod 32 ) , n} ) mod 2$$

where i=0, 1, 2, . . . , Q_{ACK}−1 and the basis sequences M_{i,n} are defined in Table 5.2.2.6.4-1.
The vector sequence output of the channel coding for HARQ-ACK information is denoted by q₀^{ACK}, q₁^{ACK}, . . . , q_{Q′}_{_{ACK}}₋₁^{ACK}, where Q′_{ACK}=Q_{ACK}/Qₘ, and is obtained as follows:

### Set i, k to 0

while i<Q_{ACK}
qₖ^{ACK}=[qᵢ^{ACK} . . . q_{1+Q}_{ₘ}₋₁^{ACK}]^{T}

i=i+Qₘ

k=k+1

end while”

Additionally, it should be noted that the number of coded symbols for ACK/NACK and RI is defined as (3GPP TS36.212 Section 5.2.2.6):

When the UE transmits HARQ-ACK bits or rank indicator bits, it shall determine the number of coded symbols Q′ for HARQ-ACK or rank indicator as

$${Q}^{′} = min ( ⌈ \frac{O \cdot {M}_{sc}^{PUSCH - initial} \cdot {N}_{symb}^{PUSCH - initial} \cdot {β}_{offset}^{PUSCH}}{{\sum }_{r = 0}^{C - 1} {K}_{r}} ⌉ , 4 \cdot {M}_{sc}^{PUSCH} )$$

where O is the number of ACK/NACK bits or rank indicator bits, M_{sc}^{PUSCH} is the scheduled bandwidth for PUSCH transmission in the current sub-frame for the transport block, expressed as a number of subcarriers, and N_{symb}^{PUSCH-initial} is the number of SC-FDMA symbols per subframe for initial PUSCH transmission for the same transport block given by N_{symb}^{PUSCH-initial}=(2·(N_{symb}^{UL}−1)−N_{SRS}), where N_{SRS} is equal to 1 if UE is configured to send PUSCH and SRS in the same subframe for initial transmission or if the PUSCH resource allocation for initial transmission even partially overlaps with the cell specific SRS subframe and bandwidth configuration defined in Section 5.5.3. Otherwise N_{SRS} is equal to 0.”

One straightforward solution is to apply QPSK constellation point selection as with 1 and 2 HARQ-ACK bits, causing effectively QPSK modulation across CWs. However, this solution is not spectrally efficient, especially when CWs use 16-QAM and 64-QAM modulation. With multiple HARQ-ACK bits a higher efficiency is expected with a lower coding rate and higher modulation order. This is at least due to the fact that in the case of carrier aggregation, especially in the TDD mode, the number of ACK/NACK bits per subframe can be relatively high (e.g., as high as 20).

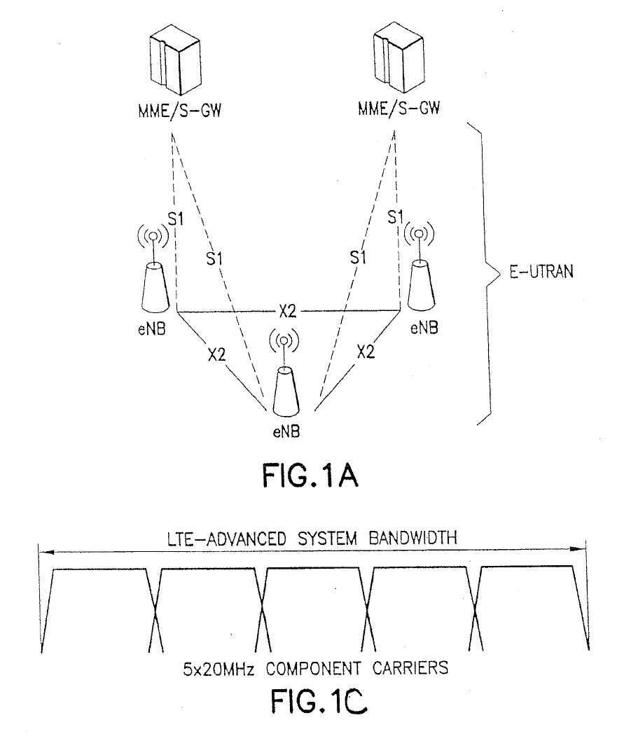

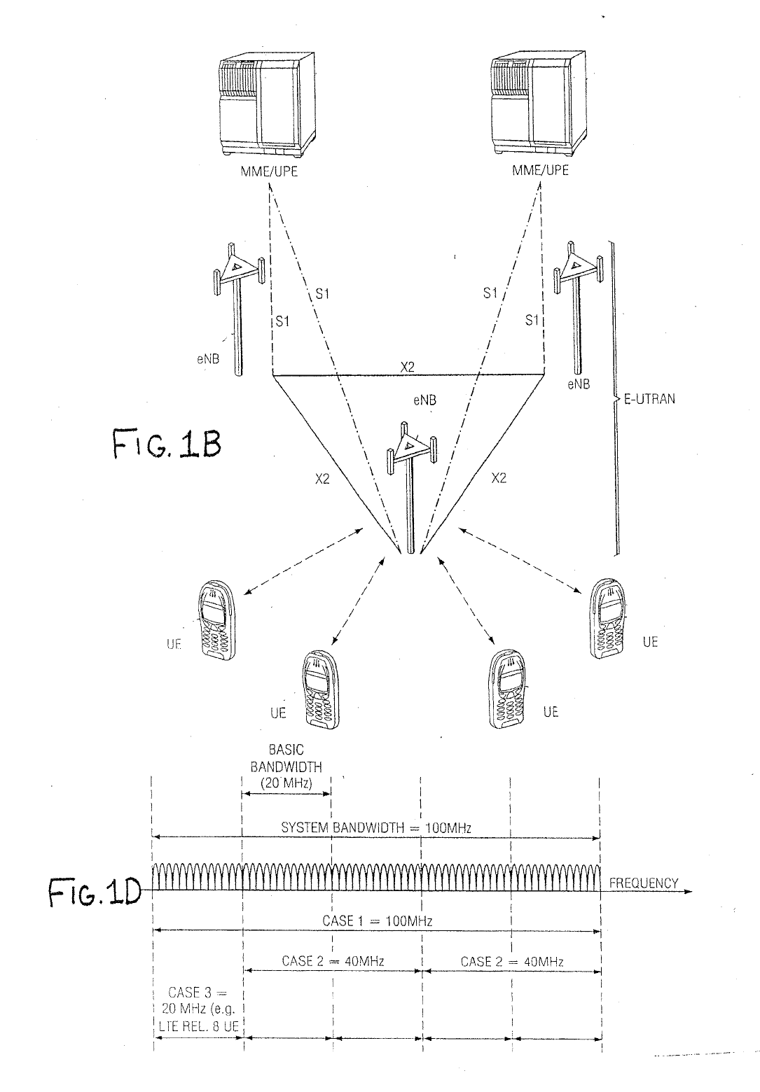

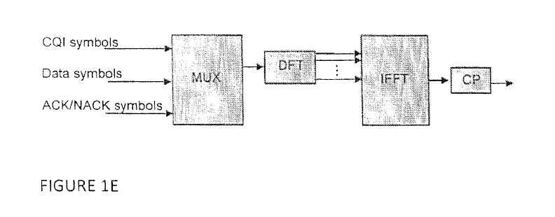

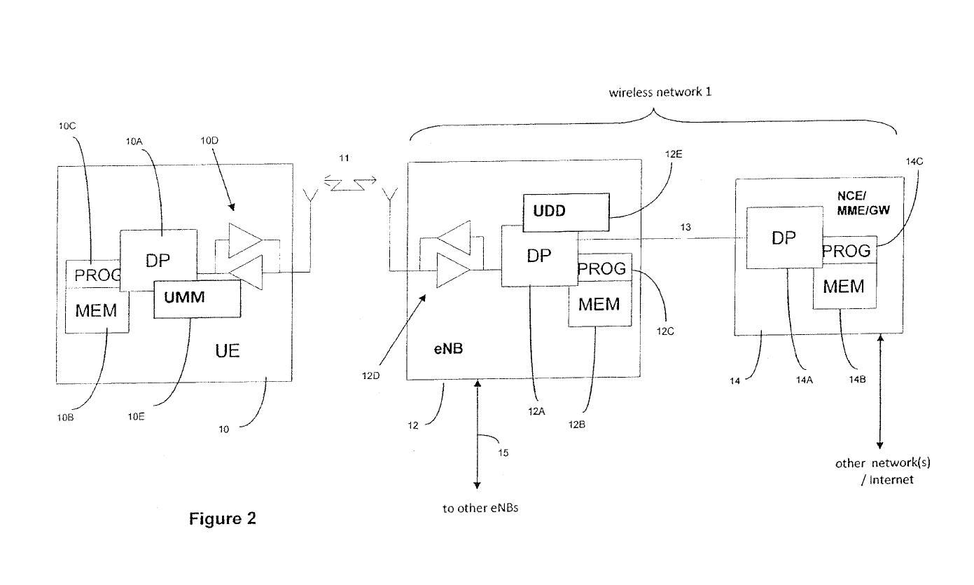

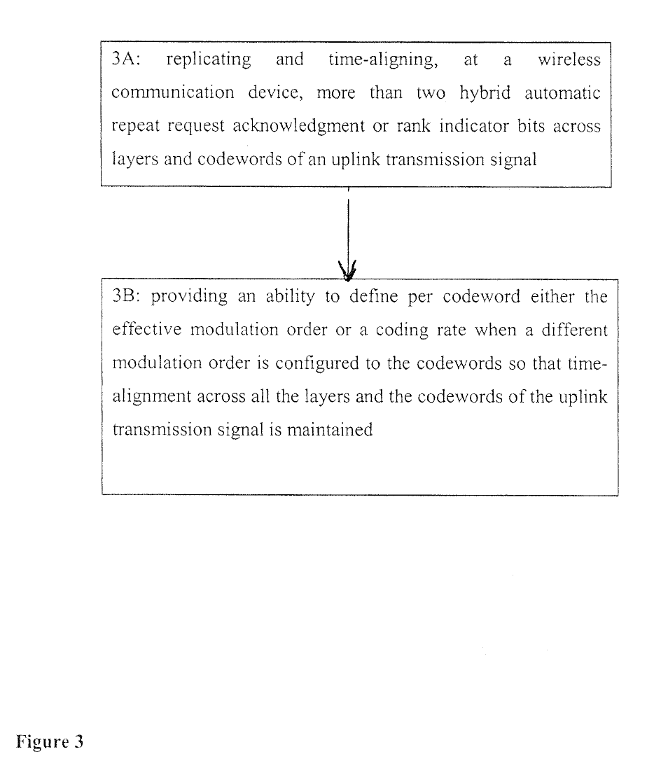

Before describing in further detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1 is adapted for communication over a wireless link 11 with an apparatus, such as a mobile communication device which may be referred to as a UE 10, via a network access node, such as a Node B (base station), and more specifically an eNB 12. The network 1 may include a network control element (NCE) 14 that may include the MME/SGW functionality shown in FIG. 1A, and which provides connectivity with a further network, such as a telephone network and/or a data communications network (e.g., the internet). The UE 10 includes a controller, such as at least one computer or a data processor (DP) 10A, at least one non-transitory computer-readable memory medium embodied as a memory (MEM) 10B that stores a program of computer instructions (PROG) 10C, and at least one suitable radio frequency (RF) transceiver 10D for bidirectional wireless communications with the eNB 12 via one or more antennas. The eNB 12 also includes a controller, such as at least one computer or a data processor (DP) 12A, at least one computer-readable memory medium embodied as a memory (MEM) 12B that stores a program of computer instructions (PROG) 12C, and at least one suitable RF transceiver 12D for communication with the UE 10 via one or more antennas (typically several when multiple input/multiple output (MIMO) operation is in use). The eNB 12 is coupled via a data/control path 13 to the NCE 14. The path 13 may be implemented as the S1 interface shown in FIG. 1A. The eNB 12 may also be coupled to another eNB via data/control path 15, which may be implemented as the X2 interface shown in FIG. 1A.

For the purposes of describing the exemplary embodiments of this invention the UE 10 can be assumed to also include an uplink multiplexing and modulation (UMM) block 10E, and the eNB 12 includes a corresponding uplink de-multiplexing and de-modulation (UDD) block 12E. These blocks 10E and 12E operate in accordance with the exemplary embodiments, as described in detail below.

At least one of the PROGs 10C and 12C is assumed to include program instructions that, when executed by the associated DP, enable the device to operate in accordance with the exemplary embodiments of this invention, as will be discussed below in greater detail. That is, the exemplary embodiments of this invention may be implemented at least in part by computer software executable by the DP 10A of the UE 10 and/or by the DP 12A of the eNB 12, or by hardware, or by a combination of software and hardware (and firmware).

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable MEMs 10B and 12B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on multi-core processor architectures, as non-limiting examples.

The exemplary embodiments of this invention provide for replication and time-alignment of more than 2 HARQ-ACK or RI bits across codewords and layers. It is noted that in the following, HARQ-ACK and RI are referred to as UCI, although commonly UCI refers also to CQI and PMI.

The exemplary embodiments modify either the effective modulation order or coding rate per CW when a different modulation order is configured to CWs so that time-alignment across all layers and both CWs is maintained.

In a first embodiment, referred to for convenience as arrangement A, UCI bits on one CW are modulated by using constellation points that are equal to or resemble constellation points used on the other CW for UCI. Additionally, encoded UCI bits are replicated across CWs and layers.

In a second embodiment, referred to for convenience as arrangement B, the number of coded bits used for UCI is divided between CWs according to a ratio of modulation orders configured for the CWs (multiplied with the ratio of spatial layers allocated for the CW to the transmission rank). Note that this multiplication is related to the different number of layers per CW, and not to the coding rate/modulation modification. UCI bits are modulated with the modulation used for data on the CW. In other words, the same UCI is transmitted time-aligned on both CWs by using different modulation and coding rates. The CW-specific coding rate compensates for different modulation orders used on CWs and, thus, provides UCI time-alignment across CWs. As a result, there are same number of coded UCI symbols on each layer, although the modulation of symbols is different between CWs.

Discussing arrangement A now in further detail, the UCI bits are first encoded and then replicated across layers and CWs. In arrangement A, there are at least two options (referred to for convenience as Option A-1 and Option A-2).

In Option A-1 the modulation used for UCI is the same on both CWs, irrespective of the modulation configured for the CW. In other words, the modulator can change the modulation used for modulating data or UCI on the other CW. Additionally, higher modulation order is selected for UCI from modulations configured for CWs. In other words, UCI modulation order is Q′ₘ=max(Qₘ¹, Qₘ²), where Qₘ¹ is the modulation order used on CW t, i.e., number of bits per symbol (2 for QPSK, 4 for 16-QAM, and 6 for 64-QAM). Number of coded UCI bits per layer is given by Q_{UCI}=Qₘ′·Q′.

There are multiple options for determining the number of coded symbols for HARQ-ACK and RI per layer. A first option is given by:

$${Q}^{′} = min ( ⌈ \frac{O \cdot {M}_{sc}^{PUSCH - initial} \cdot {N}_{symb}^{PUSCH - initial} \cdot {β}_{offset}^{PUSCH}}{max ( {\sum }_{r = 0}^{C ( t ) - 1} {K}_{r} ( t ) / L ( t ) )} ⌉ , 4 \cdot {M}_{sc}^{PUSCH} ) ,$$

where C(t), Kr(t), L(t) are the number of code blocks, number of bits for code block number r, and number of layers mapped for codeword t, respectively, for each codeword t. In the foregoing expression the maximum is taken over the configured codewords. Alternatively, the maximum can be limited to codeword/codewords using the same modulation as selected for UCI. Furthermore, min denotes minimum,
max denotes maximum,
O denotes the number of ACK/NACK or RI bits,
M_{sc}^{PUSCH-initial} denotes the scheduled bandwidth for a PUSCH transmission in the sub-frame for an initial PUSCH transmission for a transport block that is expressed in the number of subcarriers,
N_{symb}^{PUSCH-initial} denotes the number of SC-FDMA symbols per a subframe for an initial PUSCH transmission, β_{offset}^{PUSCH} denotes the offset parameter signalled to a user device via higher layers,
M_{sc}^{PUSCH} denotes a scheduled bandwidth for a PUSCH transmission in a current sub-frame for a transport block that is expressed in the number of (virtual) subcarriers, and
Σ denotes a summing operation.

The maximum is taken over CWs and the number of coded symbols per layer is determined by applying the Rel-8 principle according to the number of coded symbols on layer using highest MCS. This dimensioning preferably uses rank-specific β_{offset}^{PUSCH} values, as otherwise it will over-dimension the number of coded UCI symbols by ignoring UCI transmissions on the other layers. It should be noted that minimum with 4·M_{sc}^{PUSCH} was introduced in Rel-8 to limit HARQ-ACK (or RI) to a maximum of 4 SC-FDMA symbols (each containing M_{sc}^{PUSCH} symbols). This limitation and, thus, the function of the minimum may be removed to improve coverage for multi-bit HARQ-ACK or RI.

The second option is to take all UCI symbols into account when applying the Rel-8 principle. In other words, the number of coded symbols for HARQ-ACK and RI per layer is given by:

$${Q}^{′} = min ( ⌈ \frac{O \cdot {M}_{sc}^{PUSCH - initial} \cdot {N}_{symb}^{PUSCH - initial} \cdot {β}_{offset}^{PUSCH}}{{\sum }_{t = 0}^{T - 1} {\sum }_{r = 0}^{C ( t ) - 1} {K}_{r} ( t )} ⌉ , 4 \cdot {M}_{sc}^{PUSCH} ) ,$$

where T is the number of multiplexed transport blocks (or codewords). Again, more accurate UCI dimensioning can be achieved by using rank specific β_{offset}^{PUSCH} values or, at least, different values for single stream and multi-stream (spatial multiplexing) transmissions. In the above expression a higher modulation order is selected. It is also possible to select the lower modulation from the modulations configured for CWs. In this case the second option for determining Q′ is preferred.

In Option A-2 appropriate constellation points are selected and used for UCI modulation so that the resulting modulation resembles the modulation used on the other CW (of course, if both CWs use the same modulation then no modulation changes are needed). Option A-2, in one non-limiting embodiment, can be implemented as follows:
the number of coded bits for HARQ-ACK and RI is given by Q_{UCI}=Q′ₘ·Q′,
where Q′ₘ=min(Qₘ¹,Qₘ²) is the minimum modulation order over CWs;
the encoded UCI is replicated across layers and CWs; and
the number of coded symbols for HARQ-ACK and RI per layer is given by

$${Q}^{′} = min ( ⌈ \frac{O \cdot {M}_{sc}^{PUSCH - initial} \cdot {N}_{symb}^{PUSCH - initial} \cdot {β}_{offset}^{PUSCH}}{{\sum }_{t = 0}^{T - 1} {\sum }_{r = 0}^{C ( t ) - 1} {K}_{r} ( t )} ⌉ , 4 \cdot {M}_{sc}^{PUSCH} ) ,$$

It should be noted that with some exception configurations, Q′ may support fewer coded bits than there are UCI bits. Thus, it may be desirable to check that Q′ is at least O/Q′ₘ.

In the case that the lower modulation order is QPSK, an appropriate number of “x” placeholders (as in 3GPP TS 36.212 and 3GPP TS 36.211) are inserted after every two coded UCI bits (qᵢ^{ACK} or qᵢ^{RI}) on the CW using higher modulation order. For example, for HARQ-ACK, when the used modulation is 16-QAM, q₀^{ACK} q₁^{ACk} x x q₂^{ACK} q₃^{ACK} x x q₄^{ACK} q₅^{ACK} x x . . . and when the used modulation is 64-QAM, q₀^{ACK} q₁^{ACK} x x x x q₂^{ACK} q₃^{ACK} x x x x q₄^{ACK} q₅^{ACK} x x x x . . . .

In the case that the lower modulation order is 16-QAM, and the higher order modulation is 64-QAM with constellations determined as in 3GPP TS 36.211, a constellation resembling 16-QAM is obtained by selecting 64-QAM constellations with I- or Q-branch amplitude of 3/\sqrt{42} or 7/\sqrt{42} with constellations defined as in 3GPP TS 36.211. It should be noted that the resulting constellation is not the same as the LTE 16-QAM constellation; inner constellation points have a slightly too large amplitude and outer constellation points have a slightly too small amplitude. Appropriate constellation point selection (with 64-QAM constellation as in 3GPP TS 36.211) is achieved with introduction of placeholder “z”. Two “z” placeholders are inserted after every 4 coded bits as follows:

q₀^{ACK} q₁^{ACK} q₂^{ACK} q₃^{ACK z z} q₄^{ACK} q₅^{ACK} q₆^{ACK} q₇^{ACK} z z q₈^{ACK} q₉^{ACK} q₁₀^{ACK} q₁₁^{ACK} z z . . . .
The placeholder “z” will impact the bit-level scrambling operation as: if b(i)=z then \tilde{b}(i)=\tilde{b}(i−2), where b(i) is input bit to scrambler and \tilde{b}(i) is the scrambled bit. For reference, placeholder “y” is defined in 3GPP TS 36.211, Section 5.3.1, to have an impact as: if b(i)=Y then \tilde{b}(i)=\tilde{b}(i−1)

One particular exemplary option is that whenever a different modulation order is configured for CWs, QPSK constellation points are selected and used for the UCI on both CWs (Q′=2). This will reduce spectral efficiency for those particular configurations but, on other hand, a simple implementation and standardization is achieved.

Discussed now is the arrangement B. In this arrangement there are several options (referred to for convenience as Options B-1, B-2 and B-3).

Option B-1: Uncoded UCI bits are replicated across both CWs, after which they are separately encoded. Next the encoded UCI bits are replicated across layers allocated for the CW.

Option B-2: Uncoded UCI bits are replicated across both CWs, after which they are separately encoded for each CW. However, coding is done over all layers allocated for the CW. Encoded UCI bits are then, for example, serial-to-parallel converted on to layers allocated for the CW.

Option B-3: Uncoded UCI bits are jointly coded across both CWs and all layers after which encoded UCI bits are then, for example, serial-to-parallel converted on to the layers.

In Option B-1 the number of coded UCI bits per layer on CW t is given by Q_{UCI}=Qₘ^{t}·Q′, and the number of coded symbols for HARQ-ACK and RI per layer for CW t is given by

$${Q}^{′} = min ( ⌈ \frac{O \cdot {M}_{sc}^{PUSCH - initial} \cdot {N}_{symb}^{PUSCH - initial} \cdot {β}_{offset}^{PUSCH}}{{\sum }_{t = 0}^{T - 1} {\sum }_{r = 0}^{C ( t ) - 1} {K}_{r} ( t )} ⌉ , 4 \cdot {M}_{sc}^{PUSCH} ) .$$

In Option B-2, the number of coded UCI bits (per CW) on CW t is given by Q_{UCI}=Qₘ^{t}·Q′, and the number of coded symbols for HARQ-ACK and RI (per CW) for CW t is given by

$${Q}^{′} = min ( ⌈ \frac{O \cdot {M}_{sc}^{PUSCH - initial} \cdot {N}_{symb}^{PUSCH - initial} \cdot {β}_{offset}^{PUSCH}}{{\sum }_{t = 0}^{T - 1} {\sum }_{r = 0}^{C ( t ) - 1} {K}_{r} ( t )} ⌉ \cdot L ( t ) , 4 \cdot {M}_{sc}^{PUSCH} \cdot L ( t ) ) .$$

In Option B-3, number of coded UCI bits on CW t is given by Q_{UCI}=Qₘ^{t}·Q′·L(t)/R, where R is the transmission rank. The number of coded symbols for HARQ-ACK and RI for both CWs is given by

$${Q}^{′} = min ( ⌈ \frac{O \cdot {M}_{sc}^{PUSCH - initial} \cdot {N}_{symb}^{PUSCH - initial} \cdot {β}_{offset}^{PUSCH}}{{\sum }_{t = 0}^{T - 1} {\sum }_{r = 0}^{C ( t ) - 1} {K}_{r} ( t )} ⌉ \cdot R , 4 \cdot {M}_{sc}^{PUSCH} \cdot R ) .$$

One exemplary benefit of arrangement B is that when a ML type of detector, that tests all UCI bit sequence possibilities, is implemented on the eNB 12, the spatial interference is known and, thus, can be taken into account in the ML metric calculation. This is a significant difference to an approach where the UCI is not time-aligned across layers and CWs, as spatial interference would be caused by random PUSCH data.

There are a number of technical effects and technical advantages that can be realized by the use of the exemplary embodiments of this invention. For example, only a small additional complexity is needed beyond that used for Rel-8 operation (both at the transmitter and the receiver side). In addition, enhanced performance is achieved at least from the diversity that exists over spatial layers. In addition, the exemplary embodiments are aligned and compatible with decisions made in RAN1#61 (maintains time-alignment of the UCI across layers).

It is also noted that a multiplexing solution for multi-bit HARQ-ACK and RI on the PUSCH is needed in any case for Rel-10, as it would not be reasonable to assume that UCI transmission relies only on concurrent transmission of PUCCH and PUSCH. In fact, at this point in time it is possible that concurrent transmission of the PUCCH and the PUSCH will not be supported in Rel-10 (LTE-Advanced).

Based on the foregoing it should be apparent that the exemplary embodiments of this invention provide a method, apparatus and computer program(s) to replicate and time-align more than two HARQ-ACK or RI bits across codewords and layers, and provide an ability to modify either the effective modulation order or the coding rate per codeword when a different modulation order is configured to codewords so that time-alignment across all layers and codewords is maintained.

In a first exemplary embodiment UCI bits on one CW are modulated by using constellation points that are equal to or that resemble constellation points used on the other CW, and encoded UCI bits are replicated across codewords and layers.

In a second exemplary embodiment the number of coded bits used for the UCI is divided between codewords according to the ratio of modulation orders configured for the codewords (multiplied with the ratio of spatial layers allocated for the codeword to the transmission rank), and UCI bits are modulated with the modulation used for data on the codeword such that the same UCI is transmitted time-aligned on both codewords by using different modulation and coding rates.

FIG. 3 illustrates a simplified block diagram which describes at least a method, as may be performed by an apparatus, and a computer program executed to perform operations in accordance with the exemplary embodiments of the invention. As illustrated in block 3A of FIG. 3 there is replicating and time-aligning, at a wireless communication device, more than two hybrid automatic repeat request acknowledgment or rank indicator bits across layers and codewords of an uplink transmission signal. Further, as illustrated in block 3B of FIG. 3 there is defining per codeword either an effective modulation order or a coding rate when a different modulation order is configured to the codewords so that time-alignment across all the layers and the codewords of the uplink transmission signal is maintained.

In accordance with at least the method and computer program as illustrated above with regards to FIG. 3, there is modulating uplink control information bits on one of the codewords using constellation points that are equal to or resemble constellation points used on another of the codewords for uplink control information bits.

Further, in accordance with the paragraphs above, the uplink control information bits are replicated across at least two of the codewords of the uplink transmission signal.

In accordance with the paragraph above, the uplink control information bits are separately encoded for each of the at least two different codewords, and each of the encoded uplink control information bits is allocated across layers allocated for each of the at least two different codewords.

Further, in accordance with the paragraph above, each of the encoded uplink control information bits are then serial-to-parallel converted on to the layers allocated for each of the at least two different codewords.

In addition, in accordance with the paragraphs above, a number of coded bits used for uplink control information is divided between the codewords according to a ratio of modulation orders configured for the codewords.

In accordance with the paragraph above, the ratio of the modulation orders for the codewords is multiplied with a ratio of spatial layers allocated for the codewords according to a transmission rank of the uplink transmission signal.

Additionally, in accordance with the paragraphs above, the uplink control information bits are modulated with a modulation used for data on the codewords such that uplink control information is using a same number of coded symbols for each layer allocated for at least two different codewords using different modulation and/or coding rates.

In accordance with at least the preceeding paragraph, there is compensating, using codeword specific coding rates, for different modulation orders used on the at least two different codewords, and providing the uplink control information time-aligned across the at least two different codewords.

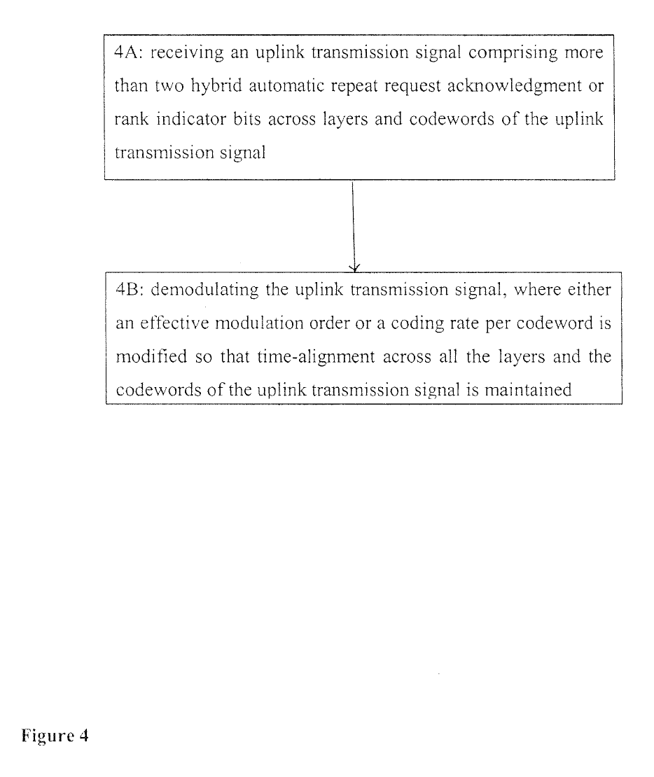

FIG. 4 illustrates a simplified block diagram which describes at least a method, as may be performed by an apparatus, and a computer program executed to perform operations in accordance with the exemplary embodiments of the invention. As illustrated in block 4A of FIG. 4 there is receiving an uplink transmission signal comprising more than two hybrid automatic repeat request acknowledgment or rank indicator bits across layers and codewords of the uplink transmission signal. As illustrated in block 4B of FIG. 4 there is demodulating the uplink transmission signal, where either an effective modulation order or a coding rate per codeword is modified so that time-alignment across all the layers and the codewords of the uplink transmission signal is maintained.

In accordance with at least the method and computer program as illustrated above with regards to FIG. 4, there is where either the effective modulation order or a coding rate per codeword is modified when a different modulation order is configured to the codewords.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant'arts in view of the foregoing description, when read in conjunction with the accompanying drawings. However, any and all modifications will still fall within the scope of the non-limiting and exemplary embodiments of this invention.

For example, while the exemplary embodiments have been described above in the context of the (UTRAN-LTE-A) system, it should be appreciated that the exemplary embodiments of this invention are not limited for use with only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., Q′ etc.) are not intended to be limiting in any respect, as these parameters may be identified by any suitable names. Further, the formulas and expressions that use these various parameters may differ from those expressly disclosed herein. Further, the various names assigned to different channels (e.g., PUSCH, PUCCH, etc.) are not intended to be limiting in any respect, as these various channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
replicating and time-aligning, at a wireless communication device, more than two hybrid automatic repeat request acknowledgment or rank indicator bits across layers and codewords of an uplink transmission signal; and
defining per codeword either an effective modulation order or a coding rate when a different modulation order is configured to the codewords so that time-alignment across all the layers and the codewords of the uplink transmission signal is maintained.

2. The method according to claim 1, comprising modulating uplink control information bits on one of the codewords using constellation points that are equal to or resemble constellation points used on another of the codewords for uplink control information bits.

3. The method according to claim 2, where the uplink control information bits are replicated across at least two of the codewords of the uplink transmission signal and then separately encoded for each of the at least two codewords.

4. The method according to claim 3, where each of the encoded uplink control information bits is allocated across layers allocated for each of the at least two codewords.

5. The method according to claim 4, where each of the encoded uplink control information bits are then serial-to-parallel converted on to the layers allocated for each of the at least two different codewords.

6. The method according to claim 1, comprising modulating uplink control information bits with a modulation used for data on the codewords such that uplink control information is using a same number of coded symbols for each layer allocated for at least two different codewords using different modulation.

7. The method according to claim 6, where a number of coded bits used for the uplink control information is divided between the at least two different codewords according to a ratio of modulation orders configured for the codewords

8. The method according to claim 7, where the ratio of the modulation orders for the codewords is multiplied with a ratio of spatial layers allocated for the codewords according to a transmission rank of the uplink transmission.

9. The method according to claim 6, comprising compensating, using codeword specific coding rates, for different modulation orders used on the at least two different codewords, and providing the uplink control information time-aligned across the at least two different codewords.

10. A non-transitory computer-readable medium that contains computer program instructions, the computer program instructions executed by at least one data processor to perform the method according to claim 1.

11. An apparatus comprising:
at least one processor; and
at least one memory including computer program code, where the at least one memory and the computer program code are configured, with the at least one processor, to cause the apparatus to at least:
replicate and time-align, at a wireless communication device, more than two hybrid automatic repeat request acknowledgment or rank indicator bits across layers and codewords of an uplink transmission signal; and
define per codeword either an effective modulation order or a coding rate when a different modulation order is configured to the codewords so that time-alignment across all the layers and the codewords of the uplink transmission signal is maintained.

12. The apparatus according to claim 11, comprising the at least one memory including the computer program code is configured, with the at least one processor, to cause the apparatus to modulate uplink control information bits on one of the codewords using constellation points that are equal to or resemble constellation points used on another of the codewords for uplink control information bits.

13. The apparatus according to claim 12, where the uplink control information bits are replicated across at least two of the codewords of the uplink transmission signal and then separately encoded for each of the at least two codewords.

14. The apparatus according to claim 12, comprising the at least one memory including the computer program code is configured, with the at least one processor, to cause the apparatus to:
separately encode the uplink control information bits for each of the at least two different codewords; and
allocate each of the encoded uplink control information bits across layers allocated for each of the at least two different codewords.

15. The apparatus according to claim 13, where each of the encoded uplink control information bits is allocated across layers allocated for each of the at least two codewords.

16. The apparatus according to claim 14, comprising the at least one memory including the computer program code is configured, with the at least one processor, to cause the apparatus to serial-to-parallel converted each of the encoded uplink control information bits on to the layers allocated for each of the at least two different codewords.

17. The apparatus according to claim 11, where the at least one memory including the computer program code is configured, with the at least one processor, to cause the apparatus to modulate uplink control information bits with a modulation used for data on the codewords such that uplink control information is using a same number of coded symbols for each layer allocated for at least two different codewords using different modulation.

18. The apparatus according to claim 17, where the at least one memory including the computer program code is configured, with the at least one processor, to cause the apparatus to divide a number of coded bits used for the uplink control information between the at least two different codewords according to a ratio of modulation orders configured for the codewords

19. The apparatus according to claim 18, where the at least one memory including the computer program code is configured, with the at least one processor, to cause the apparatus to multiply the ratio of the modulation orders for the codewords with a ratio of spatial layers allocated for the codewords according to a transmission rank of the uplink transmission.

20. The apparatus according to claim 17, where the at least one memory including the computer program code is configured, with the at least one processor, to cause the apparatus to compensate, using codeword specific coding rates, for different modulation orders used on the at least two different codewords, and providing the uplink control information time-aligned across the at least two different codewords.

21.-23. (canceled)

24. A method comprising:
receiving an uplink transmission signal comprising more than two hybrid automatic repeat request acknowledgment or rank indicator bits across layers and codewords of the uplink transmission signal; and
demodulating the uplink transmission signal, where either an effective modulation order or a coding rate per codeword is modified so that time-alignment across all the layers and the codewords of the uplink transmission signal is maintained.

25. The method according to claim 24, where the uplink transmission signal comprises uplink control information bits modulated with a modulation used for data on the codewords such that uplink control information is using a same number of coded symbols for each layer allocated for at least two different codewords using different modulation.

26. A non-transitory computer-readable medium that contains computer program instructions, the computer program instructions executed by at least one data processor to perform the method according to claim 24.

27. An apparatus comprising:
at least one processor; and
at least one memory including computer program code, where the at least one memory and the computer program code are configured, with the at least one processor, to cause the apparatus to at least:
receive an uplink transmission signal comprising more than two hybrid automatic repeat request acknowledgment or rank indicator bits across layers and codewords of the uplink transmission signal; and
demodulate the uplink transmission signal, where either an effective modulation order or a coding rate per codeword is modified so that time-alignment across all the layers and the codewords of the uplink transmission signal is maintained.

28. The apparatus according to claim 27, where the uplink transmission signal comprises uplink control information bits modulated with a modulation used for data on the codewords such that uplink control information is using a same number of coded symbols for each layer allocated for at least two different codewords using different modulation.

29.-30. (canceled)
